(19) United States
(12) Patent Application Publication
(10) Pub. No.: US 2026/0160902 A1
(43) Pub. Date: Jun. 11, 2026

(54) GNSS VALIDITY AND DEGREDATION ASSESSEMENT TOOL

(71) Applicant: Caliola Engineering, LLC, Colorado Springs, CO (US)

(72) Inventors: Adam Wilander, Bozeman, MT (US); Andrew Swain, Colorado Springs, CO (US); Thomas Halford, Colorado Springs, CO (US); Peter Parker, Sandpoint, ID (US)

(73) Assignee: Caliola Engineering, LLC, Colorado Springs, CO (US)

(21) Appl. No.: 19/387,201

(22) Filed: Nov. 12, 2025

Related U.S. Application Data
(60) Provisional application No. 63/719,721, filed on Nov. 13, 2024.

(51) Int. Cl. G01S 19/39; G01S 19/40

(52) U.S. Cl. CPC G01S 19/396; G01S 19/40

(57) ABSTRACT

A system identifies degraded positional information by combining data from Global Navigation Satellite System (GNSS) and Alternative Positional Sources (APS) such as inertial measurement units. GNSS sources generate both location data and associated metadata, while APS provide additional location reports. An error modeling module computes an APS error covariance correction to indicate the accuracy of APS data. A primary classifier receives GNSS and APS reports along with the covariance correction and performs a generalized likelihood ratio test to assess GNSS data degradation. Simultaneously, a secondary classifier analyzes GNSS metadata to produce an independent degradation assessment. A degradation aggregation module then validates the primary assessment using the secondary one, ultimately generating a comprehensive GNSS positional degradation report that identifies and confirms instances of degraded location accuracy.

### STATEMENT REGARDING FEDERAL SPONSORED RESEARCH OR DEVELOPMENT

This invention was made with Government support under contract N68335-24-C-0189 awarded by the Naval Information Warfare Systems Command. The Government has certain rights in the invention.

### BACKGROUND OF THE INVENTION

### Field Of The Invention

Embodiments of the present invention generally relate to geolocation systems, particularly in scenarios in which access to a Global Navigation Satellite System (GNSS) is degraded or denied.

### Relevant Background

Military land, sea, or air vehicles or assets operating remotely require the knowledge of their position, velocity, and time (PVT) to a certain degree of accuracy. To assure this requirement is met, many diverse geolocation systems can be deployed on a single remote asset, including Global Positioning System (GNSS) receivers, systems that utilize star tracking, Inertial Measurement Units (IMUs), or systems that track other Radio Frequency (RF) or optical signals of opportunity. The asset's navigation system is then responsible for fusing the various estimates of PVT together into a final estimate that benefits from the attractive properties of each constituent estimate.

In this context, a comprehensive fusion architecture relies on the accuracy, availability, and consistency of the constituent estimates being utilized. Faulted or otherwise degraded sensors and systems pose a unique challenge in multi-sensor fusion, as use of estimates with unmodeled flaws risks polluting the fused data. A motivating deficiency of the prior art can be found in navigation systems based on GNSS-disciplined IMUs. While tactical-and navigation-grade IMUs exhibit remarkable positioning accuracy over relatively short spans of time, they rely on accurate and consistent position fixes to estimate the various bias and drift parameters that dominate long-term errors. Due to the present invention's ability to self-identify degraded behavior in its component systems, this deficiency is addressed by embodiments thereof.

Determining a user's geolocation is an essential prerequisite for numerous other activities in many diverse fields, such as time synchronization, military force coordination, and wildlife tracking. Today, satellite-based navigation systems provide highly accurate geolocation data. However, this data is not reliable in every context; a GNSS signal may be obstructed, degraded, or intentionally denied by an adversary.

To limit the size, weight, power, and cost (SWaP-C) profile of the system described herein, as well as any external systems incorporating its methods, it is desirable to deploy an integrity monitor that only relies on components already available on the target asset. Larger remote vehicles or assets already include satellite communication terminals for communications to a geosynchronous satellite, one or more IMUs, GNSS receivers, and a navigation system, each of which may be used in the present invention. This invention makes use of these existing hardware systems and interfaces. Due to the flexibility in its design, an embodiment of the present invention may be implemented in software alone.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

The present invention establishes the necessary system and methods for a vehicle or asset to determine the validity of GNSS data in a potentially degraded environment. In “clear sky” conditions, this system integrates data from existing hardware to self-calibrate the data sources relied on in its operational mode. The crux of this method is to utilize the time when the asset has the GNSS signal available to generate a calibrated system model that is then used to decide whether the GNSS signal is potentially degraded.

According to one embodiment of the present invention, a system for identifying degraded positional information begins with one or more Global Navigation Satellite System (GNSS) data sources producing one or more GNSS location data reports of a position. The same GNSS data source also produces metadata regarding the GNSS location data reports. The system further includes one or more Alternative Positional Sources (APS) producing one or more APS location data reports for the same position. As discussed herein APS comprise a variety of other positional reporting systems such as inertial measurement units and the like.

An error modeling module is communicatively coupled to the one or more APS. The error modeling module determines an APS error covariance correction for the APS location data reports. The error covariance correction is an indication of the accuracy of the APS positional data reports.

Positional data reports from one or more GNSS data sources is received by a primary classifier. The primary classifier is also communicatively coupled to the APS data sources and configured to receive the one or more GNSS location data reports, the one or more APS location data reports and the APS error covariance correction. Using this information the primary classifier conducts a generalized likelihood ratio test between the GNSS location data reports, the APS location data reports and the APS error covariance correction to determine a primary GNSS data location report degradation assessment.

A secondary classifier is also communicatively coupled to the one or more GNSS data sources. This classifier is configured to receive the metadata for the GNSS location data reports and creates a secondary GNSS data location report degradation assessment. Finally, a degradation aggregation module validates the primary classifier degradation assessment based on the secondary GNSS data location report degradation assessment producing a GNSS positional degradation report.

In other embodiments of the present invention, the system for identifying degraded positional information includes a variety of APS data sources including inertial navigation systems, terrestrial radio navigation systems, visual and optical systems, and geophysical positioning. In other versions of the present invention the error modeling module includes a calibration module configured, responsive to being in a calibration mode, to compare APS location data reports with ground truth data modeling corrections to the positional determination output of each APS. For example, the error modeling module, in one version of the present invention can compute an error correction estimate for each APS location data report for the position. The APS error covariance correction, in another embodiment of the present invention, is an aggregation of the error correction estimate for each APS location data report for the position.

The secondary classifier analyzes GNSS metadata. This metadata can include GNSS measurement and collection data, receiver configuration data, spatial contextual data, temporal and session data, and processing and validation data. Each or all this information is used by the secondary classifier create to a secondary GNSS data location report degradation assessment.

One methodology for identifying degraded positional information begins with producing, by one or more Global Navigation Satellite System (GNSS) data sources, a GNSS location data reports of a position and metadata regarding that location. Concurrently, Alternative Positional Sources (APS) produce APS location data reports for that same position.

An error modeling module receives data from the APS sources and determines an APS error covariance correction for the APS location data reports. The primary classifier receive the GNSS location data reports from the GNSS data sources and the one or more APS location data reports from the APS data sources as well as the APS error covariance correction.

Using the information received the primary classifier conducts a generalized likelihood ratio test between the GNSS location data reports, the APS location data reports, and the APS error covariance correction to determine a primary GNSS data location report degradation assessment.

At the same time the secondary classifier receives metadata for the one or more GNSS location data reports and creates a secondary GNSS data location report degradation assessment. Lastly, a GNSS positional degradation report is generated upon validation of the primary classifier degradation assessment based on the secondary GNSS data location report degradation assessment.

Other features of the methodology for identifying degraded positional information include calibrating the error modeling module by comparing APS location data reports with ground truth data thereby modeling corrections to the positional determination output of each APS. When multiple APS sources are used the present invention forms an error correction estimate for each APS location data report and aggregates the estimates forming the APS error covariance correction.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

Features and objects of the present invention and the manner of attaining them will become more apparent, and the invention itself will be best understood, by reference to the following description of one or more embodiments taken in conjunction with the accompanying drawings and figures imbedded in the text below and attached following this description.

FIG. 1 shows a high-level diagram of the system context of the GNSS situational awareness tool according to one embodiment of the present invention.

FIG. 2 is an illustration of an error covariance correction procedure used in concert with the GNSS situational awareness tool according to one embodiment of the present invention.

FIG. 3 represents a statistical test used in a one embodiment of the GNSS situational awareness tool of the present invention. This test compares the output of one sensor with redundant measurements to decide if the former represents degraded, inconsistent data.

FIG. 4 represents a classification-based system element that utilizes other informative data features to support the identification of degraded sensor data of the GNSS situational awareness tool according to one embodiment of the present invention.

FIG. 5 is a state diagram for one embodiment of the GNSS situational awareness tool of the present invention.

FIG. 6 presents a logic table defining the merging of classifier outputs into a single system output according to one embodiment of the GNSS situational awareness tool of the present invention.

FIGS. 7A and 7B illustrate a flowchart of a methodology for identifying degraded positional information, according to one embodiment of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

A system and associated methodology is presented hereafter by way of example for a vehicle or asset (system) to determine the validity of GNSS data in a potentially degraded environment. In “clear sky” conditions, this present invention integrates data from alternative position systems, among other things, to self-calibrate data sources relied upon in its operational mode. The present invention samples GNSS date over a period and compares it to positional data derived from other means to generate a calibrated system model that is then used to decide whether the GNSS signal at another point in time is potentially degraded.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

The terminology used herein is for the purpose of describing embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the term “Alternate Positioning Source (APS)” refers to any non-GNSS source of PVT. This system may produce an estimate of the target's position, velocity, or both. The system must produce a corresponding error covariance matrix. The representation of a time point, position (and/or velocity), and an error covariance matrix is otherwise referred to as “track data.”

As used herein, the term “Global Navigation Satellite Systems (“GNSS)” is a general term used to describe any satellite-based system that provides positioning, navigation, and timing (PNT) information to users anywhere on Earth. GNSS consists of a constellation of satellites orbiting Earth that transmit precise time and orbital data. Ground receivers (like those in smartphones, cars, aircraft, or surveying instruments) use these signals to determine their location (latitude, longitude, altitude) and time. There are several GNSS systems operated by different countries or organizations. They include GPS, GLOSNASS, Galileo, BelDouBeiDou, NavIC, and OZSS.

As used herein, a Generalized Likelihood Ratio Test (GLRT) is a statistical method used for hypothesis testing to determine when a set of observed data is consistent with a certain model, particularly when some parameters of the models are unknown. A GLRT framework allows a decision to be made about the validity of the GNSS signal by comparing two competing hypotheses about the received navigation data:
Null Hypothesis (H₀ H_0): The GPS signal is reliable and the differences between the GNSS track and the Alternate Position, Navigation, and Timing (APNT) sensor (APS) data are due only to normal, predictable errors. The system would have a statistical model for what “normal” looks like.
Alternative Hypothesis (H₁H_1): The GNSS signal is being compromised (e.g., spoofed or jammed), and the differences between the GNS and APS tracks are too large to be explained by normal errors. The data is better explained by a model that includes an anomaly.

The GLRT process works as follows:
1. Formulate the Likelihoods: The system calculates the likelihood (or probability) of observing the given navigation data under each hypothesis (H₀ and H₁).
2. Estimate Unknown Parameters: Critically, the GLRT uses Maximum Likelihood Estimation (MLE) to estimate any unknown parameters within each model, such as the exact noise characteristics of the APNT sensors in the current environment. This aligns with the system's function of “independently estimat[ing] the error statistics of each APS's data.”
3. Compute the Likelihood Ratio: It then calculates the ratio of the likelihood under the alternative hypothesis to the likelihood under the null hypothesis. The logarithm of this ratio is often used for mathematical convenience.
4. Compare to a Threshold: This likelihood ratio is compared against a pre-defined threshold. If the ratio exceeds the threshold, it is determined that the data is significantly more likely under the “GNSS is compromised” hypothesis (H₁), and an alert is triggered.

The “pre-defined threshold” referred to herein is generally selected to target a specific false alarm probability (decide in favor of the alternative hypothesis H₁ given the null hypothesis Ho is correct). If a closed-form representation of the false alarm probability in terms of the pre-defined threshold is available, this may be directly inverted to find a threshold value. Alternately, the pre-defined threshold can be tuned empirically according to the following procedure:
1. Sample Data: in calibration mode, select n time-aligned data points from the APS and GNSS track data.
2. Compute the Test Statistics: for each sampled point, compute (and record) the test statistic defined by Steps 1, 2, and 3 of the GLRT process.
3. Construct the CDF Estimator: construct the cumulative distribution function (CDF) of the empirical distribution of the test statistics.
4. Find the Threshold Value: find the value of the CDF that corresponds to 1-P_{FA}, where P_{FA} is the desired false alarm probability. This is commonly known as the 1-P_{FA} percentile of the test statistic values. That is, if the target false alarm probability is 5%, one finds the threshold value that is larger than 95% of the sample values.

The use of a GLRT is particularly valuable for this system due to its ability to handle composite hypotheses where some parameters (like the precise nature of the error in a contested environment) are unknown. It provides a robust, statistical basis for detecting a problem with the GNSS signal, enabling the system to:
Decide on GNSS data consistency: Make a sound, data-driven decision on whether the GNSS track is reliable.
Aid sensor fusion: Provide corrected APNT sensor data to the navigation system, improving overall accuracy and reliability, especially when the GNSS signal is compromised.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to describe a methodology for determine whether GNSS data is degraded. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

It will also be understood by those familiar with the art, that the invention may be embodied in other specific forms without departing from the spirit or essential characteristics thereof. Likewise, the naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

In a preferred embodiment, the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform tasks or implement abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be in both local and remote memory storage devices.

An exemplary system for implementing the invention includes a general purpose computing device such as the form of a conventional personal computer, a personal communication device or the like, including a processing unit, a system memory, and a system bus that couples various system components, including the system memory to the processing unit. The system bus may be any of several types of bus structures including a memory bus or memory controller, a peripheral bus, and a local bus using any of a variety of bus architectures. The system memory generally includes read-only memory (ROM) and random access memory (RAM). A basic input/output system (BIOS), containing the basic routines that help to transfer information between elements within the personal computer, such as during start-up, is stored in ROM. The personal computer may further include a hard disk drive for reading from and writing to a hard disk, a magnetic disk drive for reading from or writing to a removable magnetic disk. The hard disk drive and magnetic disk drive are connected to the system bus by a hard disk drive interface and a magnetic disk drive interface, respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer may also be used in the exemplary operating environment.

One or more embodiments of the present invention assess the validity of a GNSS signal by using data from one or more Alternate Position, Navigation, and Timing (APNT) sensors (APS). By comparing GNSS track data (position coordinates and known error profile) with reliable APS track data, a decision can be made on the consistency of GNSS track; this decision can then be relayed to an asset's navigation system increasing their situational awareness.

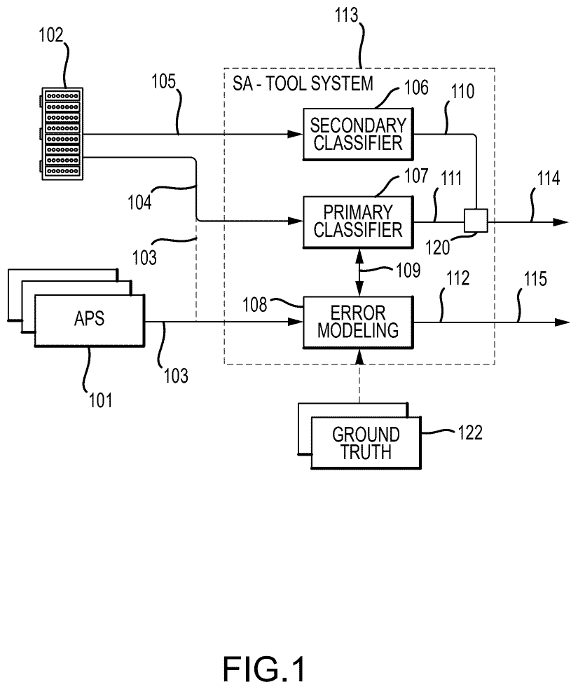

FIG. 1 illustrates a high level system diagram of a GNSS situational awareness system according to one embodiment of the present invention. In this rendering of rendering of the GNSS situational awareness system (113) GNSS data is collected from a plurality of data sources and analyzed against comparable positional data acquired through other means, thereby determining the validity of and/or degraded nature of the GNSS data. The GNSS situational awareness system (113) of the present invention ingests data from one or more each of the following subsystems:
1. One or more APS (101) provide estimated track/positional data.
2. The GNSS aggregator (102) provides GNSS-derived track/positional data (104) from one or more GNSS receivers. Data from multiple GNSS receivers is aggregated, each possessing a unique identifier for each receiver in the data stream (104).
3. The GNSS aggregator (102) also provides quantitative or categorical data stream data stream (105) (referred to herein as “auxiliary data” or “metadata”) that is used, in one embodiment, to support the identify identification of degradation in a GNSS data stream.
4. A Ground truth source (122) supplies ground truth data (116)

The GNSS situational awareness system (113) includes four major function blocks:
1. The Error Modeling element (108) is configured to ingest the merged span of raw APS tracks (103) in view of an existing known (true) location. This element passes the track data (103) along with any learned APS error model information (109) to the Primary Classifier element (107). The error model information is also output separately (115) for configuration
2. The Primary Classifier element (107) compares the GNSS track/positional data (104) with/acks/positional information from the alternate positioning sources (103, 109) thereby determining whether anomalies exist in the GNSS track data.
3. The Secondary Classifier element (106) concurrently uses GNSS metadata (105) to determine if a corresponding GNSS receiver is compromised.
4. The degradation aggregation module (120) combines the primary classifier output (111) with that of the output of secondary classifier (110) to create a validity decision/degradation report (114).

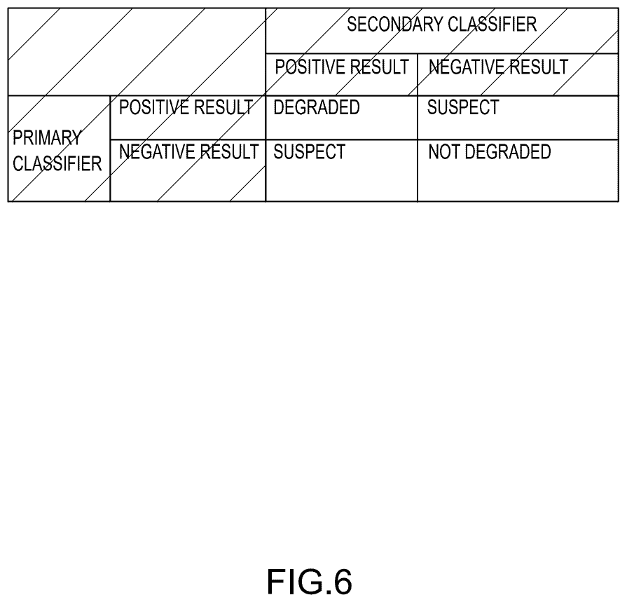

The output of the GNSS situational awareness software system (113) is a validity indication (114) illustrating to a user whether the GNSS data is degraded and/or valid. In one embodiment of the present invention, the output from the Primary and Secondary Classifiers (108 and 106) is combined by a degradation aggregation module (120) into a validity decision (degradation report) by a logic table such as the one shown in FIG. 6. In this context, the output of one classifier is used to support the other classifier's result. For example, a positive result for one classifier (representing the detection of degradation in the target sensor) is only translated into a DEGRADED system output if the other classifier reports a positive result. Likewise, a negative result for one classifier is only translated into a NOT DEGRADED result if the other classifier reports a negative result. In all other cases, this system embodiment produces a SUSPECT output.

As used herein, the phrase “operating mode” refers to a system configuration or state that defines how the system performs one or more functions during operation to produce the degradation report outlined above. Different operating modes may result in different control flows, processing behaviors, or performance outcomes.

One embodiment of the GNSS situational awareness software system includes the following operating modes:
1. In Idle mode, GNSS input data. (104) is not processed, and output data (110, 111) is not produced by the GNSS situational awareness system (113).
2. In Operational mode, input data (104, 103) is processed and output data (110, 111, 114) is produced by the GNSS situational awareness system.
3. In Calibration mode, input data (104, 103) is processed, though output data (110, 111, 114) is not produced by the GNSS situation awareness system (113). The Error Modeling element (108) described herein is only active in this mode.

Recognize in describing the present invention, the term “command” refers to any mechanism by which data is passed between system components. In various embodiments, this term may represent a user interface (UI) element like a button, a text-based interface such as a command prompt, or programmatic control signals. Commands may be named herein for instructional purposes; however, such names are not intended to limit the scope of this invention nor impose constraints on the system's organization.

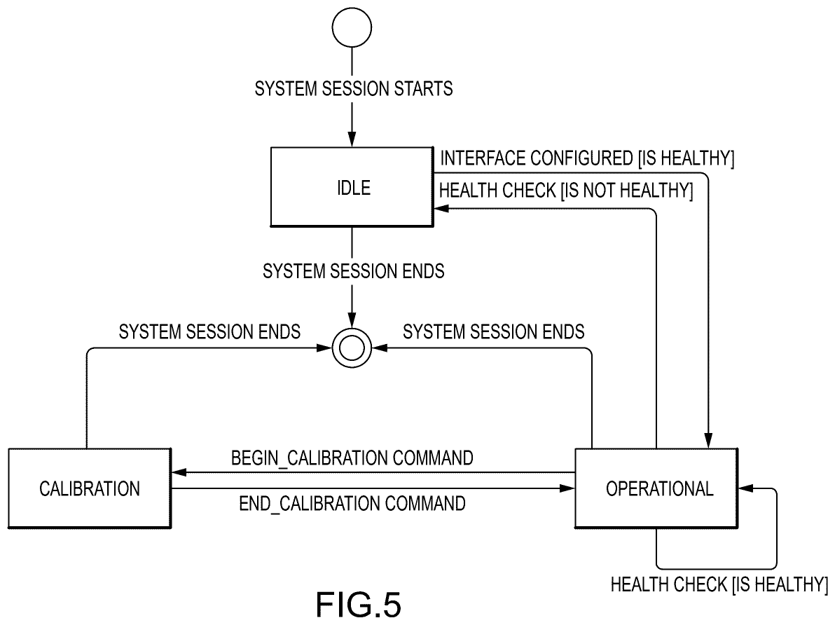

In the same embodiment described above, the system transitions between operational, idle and celebrative calibration states as shown in FIG. 5.
1. The system begins in Idle mode.
2. The system transitions to Operational mode upon successful and timely receipt of data from its component data interfaces. Lacking data for a predetermined period, the system reverts to Idle mode.
3. The system transitions to (and from) Calibration mode upon receipt of a user-issued BEGIN_CALIBRATION (resp. END_CALIBRATION) toggle command.

### The Error Modeling Element

The Error Modeling element is configured to improve the consistency of positioning estimates from each APS data stream. As discussed herein, one difficulty with standard non-linear filter-based approaches to positioning (such as the extended Kalman filter) is the potential inaccuracy in estimates due to, for instance, unmodeled process dynamics and non-linearity in the system's measurement model. In Calibration mode of the present invention, the Error Modeling element estimates corrections to the positional determination output of each APS. This estimation process is herein referred to as the “error covariance correction procedure.”

The error covariance correction procedure requires a span of APS track data. Over the sampled period, and with the ingestion of a high-quality ground truth position report, the error modeling element identifies and corrects inaccuracies in existing APS error models. This truth data is herein referred to as “training data.” Embodiments of this procedure tune the span of training data used to improve model mismatch and reduce errors in the learned mapping model.

In one embodiment of the error covariance correction procedure, the ground truth track data is taken to be a partial span of the GNSS track data stream. This data must be annotated as high-quality (that is, not from a degraded source). Various embodiments of this procedure may annotate the GNSS track data through automatic or manual means (such as direct curation by an operator).

In other embodiments of the present invention the ground truth data may be verified ground positional information. For example, if a mobile asset which includes various APS positional data is physically located at a known ground location, the APS data can be modeled and its error covariance compared to its actual location. The existing error model can be refined and used by the primary classifier (107).

The error covariance correction procedure estimates a “mapping,” herein referring to some correspondence from one data instance to another, from the space of available data to the space of covariance matrices for APS track data. The GNSS situational awareness system is configured so that this mapping is accessible by the primary classifier (107) when in Operational mode.

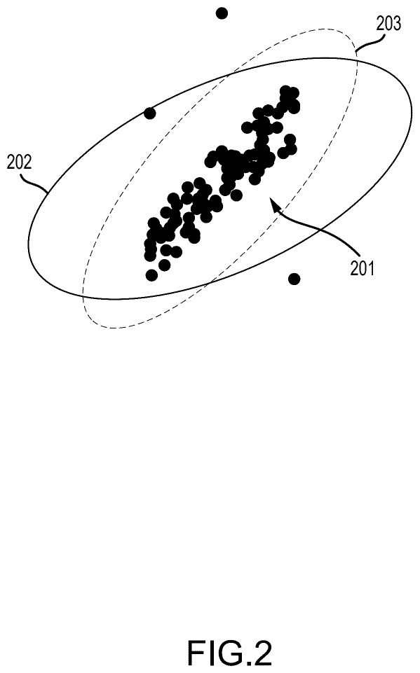

The procedure relies on performing the following steps, as depicted in and with further consideration of FIGS. 2, 3, 7A and 7B. In this example, the ground truth is a variety of high quality GNSS data/positional reports. Other ground truth data can be used and is indeed contemplated for use with the present invention.
1. For a given time-window of high-quality GNSS data or other ground truth data, a time series of APS data is collected with a and first error covariances (202) are collected.
2. The time series of GNSS data (latitude and longitude position with known error covariance) is resampled to match the time instants for each APS data point.
3. Ground truth error vectors (201) are calculated by differencing the time series (1) and (2). In the depiction of FIG. 2, each dot is a ground truth error vector. In this example the first error covariance model, using each dot, predicts an error model shown in the solid line (202). However, removing outliers and examining the convergence of the remaining ground truth error vectors yields a different result.
4. Using a convergence of the ground truth error vectors (201) as input (less fewer outliers), an estimation procedure yields a more accurate second error covariance (203).

In one embodiment of the present invention, the estimation procedure referred to above is an empirical covariance estimator creating an error covariance correction. In this embodiment, the error covariance correction procedure is performed for each APS independently.

In other embodiments, an optimal map from a feature space over the data (to include, at minimum, the APS-predicted covariance, the APS-predicted position and velocity, and the number of visible satellites) to the space of covariance matrices is learned. Other means by which to model covariance errors of the ground truth error vector is contemplated and within the scope of the present invention.

### The Primary Classifier Element

In a preferred embodiment of the present invention, the elements and methods used for detection and classification of GNSS degradation are configured in a two-tier classification architecture. This architecture combines the results of a model-based statistical detector with a data-driven classifier to complement the strengths of each and improve detection performance. The two subcomponents of this approach are herein referred to as the Primary Classifier (107) and Secondary Classifier (106), respectively.

The Primary Classifier element is configured to produce a determination on whether GNSS tracks ingested or otherwise processed are consistent with the APS tracks ingested or otherwise processed. To do so the following steps are performed.
1. The Primary Classifier element processes the latest APS track data and GNSS data. In one embodiment of the present invention, this data may contain a latitude/longitude position estimate and an associated covariance matrix.
2. The Primary Classifier element applies the latest covariance estimate correction to this APS track data, as accessed from the Error Modeling element.
3. GNSS track data is resampled to obtain a pseudo-measurement of a latitude/longitude position with known covariance.
4. The corrected APS track data is combined with the latest GNSS track data and used as the input to a binary classification procedure. The output of the binary classification procedure may be expressed as a Boolean value (TRUE/FALSE), a numeric value (0/1), or any other suitable indicator.

In certain embodiments, the output of the binary classification procedure may indicate the presence or absence of degradation in a GNSS source. For example, a TRUE output may correspond to the detection of spoofing. In other embodiments, the classification may be used to trigger further analysis.

In one embodiment, the binary classification procedure is based off a statistical hypothesis test. Here, a likelihood ratio test compares the track data under the hypothesis of no spoofing to the track data under the hypothesis of spoofing. In this embodiment, the GNSS and APS tracks are first time-aligned by resampling the data streams.

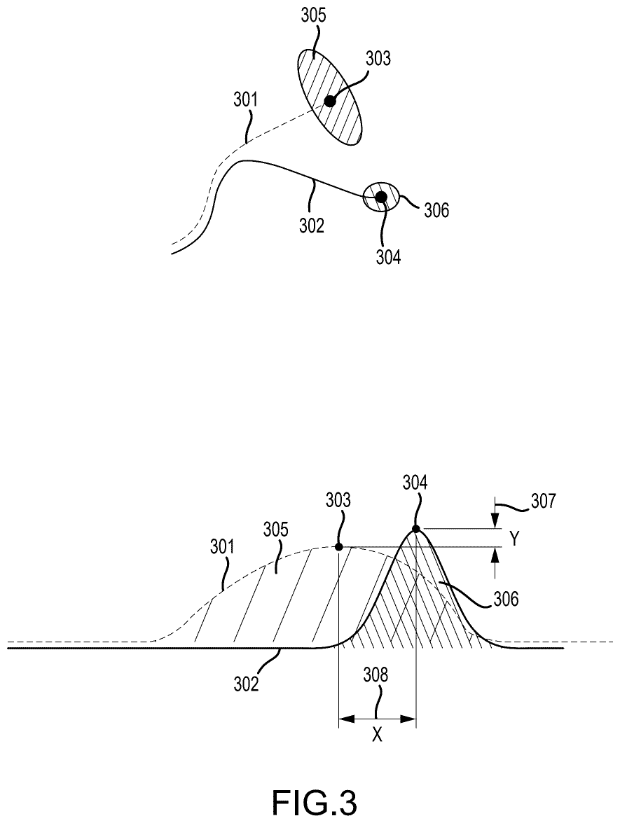

The classification procedure is a determination if the differences between the APS and GNSS tracks are too significant to warrant a no-spoofing (GNSS data is valid) conclusion. Consider the GNSS and APS track data shown in FIG. 3. The left portion of FIG. 3 presents two sources of track (positional) data (301, 302) and an associated covariance matrix (305, 306). In this example the dashed line (301) represents historical APS track data, while the solid line (302) represents historical GNSS track data. For a time-aligned positional location (303). The APS's current positional data and associated covariance (confidence) is represented by the distinct point (303) and surrounding area (305). Similarly, the GNSS's current positional data and associated covariance is represented by the distinct point (304) and surrounding area (306). solid line represents GNSS track data for the same time-aligned positional location (304). Each system, APS vs GNSS, identifies different coordinates indicated by the two distinct points (303, 304) and each has a different covariance (confidence) illustrated by the area (305, 306) surrounding the dots.

The graph to the right of the lines represents a statistical model of the estimates (303, 304) and covariances (305, 306). Again, the dashed line represents the APS track data and the solid line the GNSS track data. The peaks of each curve signify the difference in aforementioned estimates, while each curve's shape signifies the difference in their associated covariances. The difference (308) in the estimates (303, 304) and overlap of the area lying under both curves (???) are compared to determine if the GNSS track data is valid. While valid vs. non-valid is a binary determination, various degrees of degradation can be reported. For example, if the coordinates of each track (APS and GNSS) were closely aligned but the covariance on each was high the classifier may indicate that the GNSS data is valid but with a smaller value of the test statistic. Multiple data reports of the track data (114) and covariance error modeling information (115) are contemplated.

As shown in FIG. 3, the peak corresponds to the estimates (303, 304) from the previous panel. The general shape of each corresponds to the covariances (305, 306) from the previous panel. Indeed the area under the curves represents significant differences in the covariance error models. The difference (308) in the estimates (303, 304) and overlap of the area lying under both curves (???) are compared is aa smaller value of the test statistic.

### The Secondary Classifier Element

The Secondary Classifier element is configured to strengthen the decision made by the Primary Classifier element. This element operates on “side data,” or “metadata” which here refers to features derived from any non-PVT data accessible via the GNSS aggregator. In certain embodiments, this data may include numerical features such as carrier-to-noise ratios or relevant categorical data such as validity bits.

The Secondary Classifier element uses a “binary classifier,” which herein refers to an algorithmic component configured to map features to one of two classes. For example, in one embodiment, this classifier is configured to detect the explicit presence or absence of degradation in a GNSS source. In another embodiment, this classifier is configured to identify unexpected data, in the sense that a TRUE result is instead used to trigger further analysis.

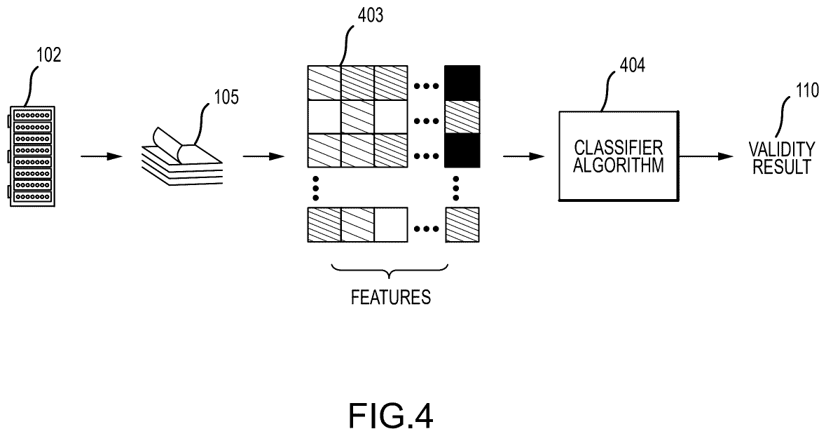

During Operational mode, the Secondary Classifier element performs the following tasks, as depicted in FIG. 4:
1. The Secondary Classifier element (106) ingests a batch of side data (105) from the target's GNSS aggregator (102).
2. The Secondary Classifier element (106) maps the side data to a feature

### Vector (403).

3. The Secondary Classifier element uses the feature vector as input to a generic binary classifier algorithm (404).
4. The output of the binary classifier (404) is a GNSS validity result (110), which may be interpreted as described herein and conveyed to the degradation aggregation module (120).

In this context, the previous mapping rule is understood to be learned within the theoretical framework of supervised learning. In this context, a practitioner has available a set of training data that consists of instances of feature vectors as well as the desired, labeled outcome for each. In one embodiment, the labels attached to this data are VALID (equivalently, TRUE), INVALID (equivalently, FALSE), or any reasonably equivalent set of labels that refer to the state of the potentially degraded sensor under study.

One end-to-end embodiment of the binary classifier that will be understood by those familiar in the art is a Mahalanobis distance-based anomaly detector paired with a robust covariance estimator. The Mahalanobis distance is a generalization of the well-known z-score, measuring the distance between a multivariate data point and a modeled probability distribution. Covariance estimation was previously discussed in the description of the Error Modeling element.

In this context, “trained model,” “trained feature mean,” and “trained feature covariance” are used to denote the statistical model formed from a sample of feature vector data (that is, “training data”) by any suitable means. We assume, without loss of much generality, that all feature vector data is numerical in nature. In this case, the sample mean and sample covariance can be used as non-robust (sensitive to outliers) statistics. Robust alternatives, such as the minimum covariance determinant (MCD), can also be used in this context.

The training data set used in this embodiment is a span of feature vector data that has been annotated as non-degraded. This is desired because the classifier is configured to identify deviations from its model of non-degraded behavior. Additionally, in many practical settings, degraded data is sparsely available and heterogeneous, making proper modeling of the degraded class impractical.

In one embodiment, the binary classifier performs the following tasks:
1. Extract Features: a feature vector (403) is formed from the most recent side data.
2. Compute Mahalanobis Distance: the distance between the feature vector (403) and trained feature mean is used, together with a trained feature covariance, to compute the distance from the feature vector to the trained model.
3. Compare to a Threshold: this distance is compared against a pre-defined threshold. If the distance exceeds the threshold, it is determined that the data significantly deviates from the trained model and is treated as a positive detection result.

Other end-to-end embodiments of this binary classifier that will be understood by those familiar with the art are the following:
1. Logistic regression.
2. Support vector machines (SVMs).
3. Random forests.

The output (114) of the GNSS situational awareness system (113) is a validity decision/degradation indicator. In one embodiment of the present invention, the output (111) from the Primary Classifier (107) and the output (110) from the Secondary Classifier (106) is combined by the aggregation module (120) into a validity decision (114) by a logic table such as the one shown in FIG. 6. In this context, the output of one classifier is used to support the other classifier's result. For example, a positive result for one classifier (representing the detection of degradation in the target sensor) is only translated into a DEGRADED system output if the other classifier reports a positive result. Likewise, a negative result for one classifier is only translated into a NOT DEGRADED result if the other classifier reports a negative result. In all other cases, this system embodiment produces a SUSPECT output.

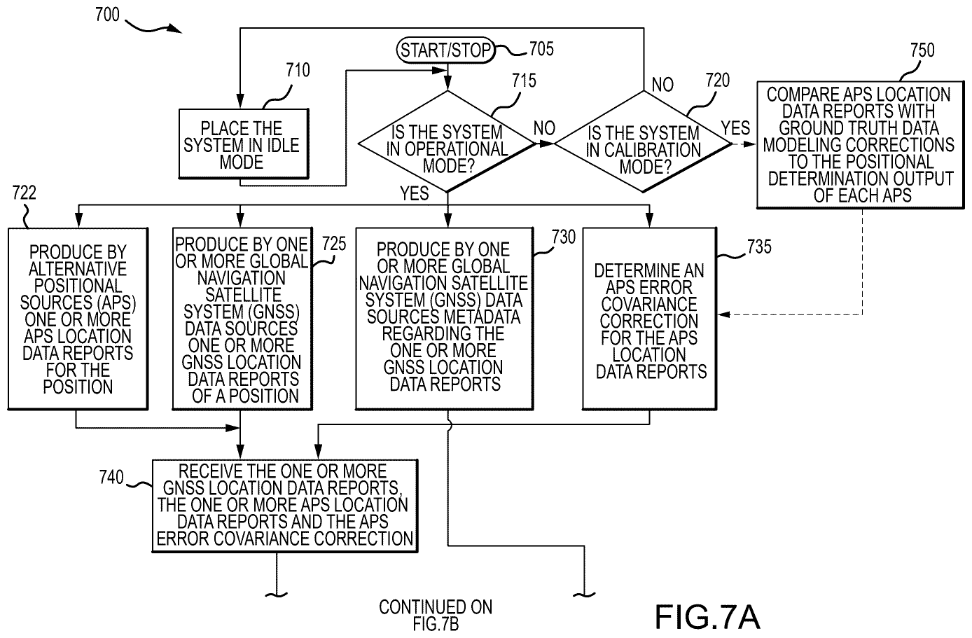

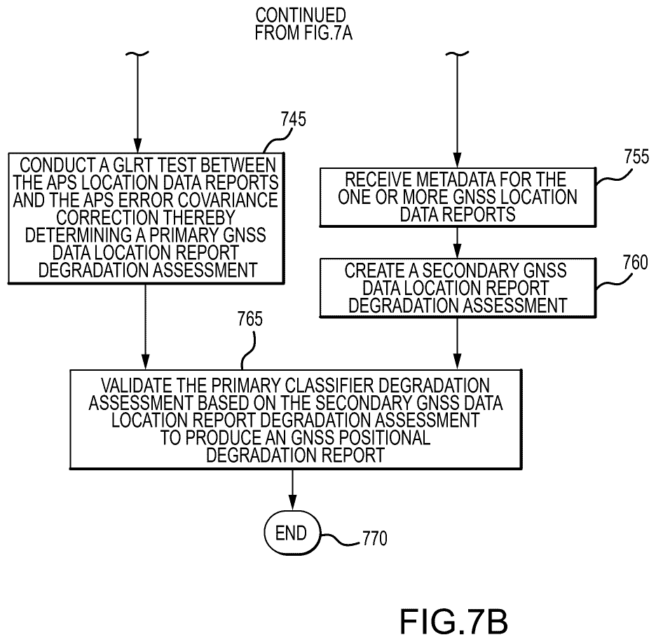

As used herein, the phrase “operating mode” refers to a system configuration or state that defines how the system performs one or more functions during operation. Different operating modes may result in different control flows, processing behaviors, or performance outcomes as illustrated in FIG. 7.

One methodology (700) for determining is GNSS positional data is degraded or spoofed is found in FIG. 7. The process begins (705) with determining (715) if the system is in an operational mode. If not, an inquiry (720) is made if the calibration mode has been initiated. When the system is neither in the operational mode nor the calibration mode, the system remains idle (710). When the system is in calibration mode APS data reports are compared (750) with ground truth data modeling corrections to the positional determination output of each APS. This information is then fed back to the error modeling module for determination (735) of an APS error covariance correction for the APS location data reports.

When the system is placed in an operational mode GNSS location data reports of a position (725), and GNSS data source metadata regarding the GNSS data reports (730), produced by a GNSS data source are received by the system. Concurrently an APS error covariance correction for an APS location data report, for the same position is crafted (735). The primary classifier receives (740) the GNSS location data reports, the one or more APS location data reports and the APS error covariance correction and conducts (745) a GLRT test to determine a primary GNSS data location report degradation assessment.

Concurrently, the secondary classifier, upon receipt (755) of GNSS data source metadata for the one or more GNSS location data reports, creates (760) a secondary GNSS data location report degradation assessment. The system thereafter validates (765) the primary classifier degradation assessment based on the secondary GNSS data location report degradation assessment received from the secondary classifier producing the final, GNSS positional degradation report, ending the process (770).

Embodiments of the present invention as have been herein described may be implemented with reference to various wireless networks and their associated communication devices. Networks can also include mainframe computers or servers, such as a gateway computer or application server (which may access a data repository). A gateway computer serves as a point of entry into each network. The gateway may be coupled to another network by means of a communications link. The gateway may also be directly coupled to one or more devices using a communications link. Further, the gateway may be indirectly coupled to one or more devices. The gateway computer may also be coupled to a storage device such as data repository.

Embodiments of the present invention, described herein, determine the validity of GNSS data in a potentially degraded environment. By integrating data from alternative position systems, among other things, the system self-calibrates data sources. The present invention samples GNSS date over a period and compares it to positional (APS) data derived from other means to generate a calibrated system model that is then used to decide whether the GNSS signal at another point in time is potentially degraded. The present invention addresses the long-felt need to determine if, and when, a GNSS position is degraded or spoofed.

While there have been described above the principles of the present invention in conjunction with aa GNSS validity and degradation assessment tool, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A system for identifying degraded positional information, the system comprising
one or more Global Navigation Satellite System (GNSS) data sources producing one or more GNSS location data reports of a position and metadata regarding the one or more GNSS location data reports;
one or more Alternative Positional Sources (APS) producing one or more APS location data reports for the position;
an error modeling module communicatively coupled to the one or more APS wherein the error modeling module determines an APS error covariance correction for the APS location data reports;
a primary classifier communicatively coupled to the one or more GNSS data sources and the one or more APS data sources and configured to receive the one or more GNSS location data reports, the one or more APS location data reports and the APS error covariance correction and wherein the primary classifier conducts a generalized likelihood ratio test between the GNSS location data reports, the APS location data reports and the APS error covariance correction to determine a primary GNSS data location report degradation assessment;
a secondary classifier communicatively coupled to the one or more GNSS data sources and configured to receive metadata for the one or more GNSS location data reports, and configured to create a secondary GNSS data location report degradation assessment; and
a degradation aggregation module configured to validate the primary classifier degradation assessment based on the secondary GNSS data location report degradation assessment producing a GNSS positional degradation report.

2. The system for identifying degraded positional information according to claim 1, wherein the one or more APS includes inertial navigation systems

3. The system for identifying degraded positional information according to claim 1, wherein the one or more APS includes terrestrial radio navigation systems

4. The system for identifying degraded positional information according to claim 1, wherein the one or more APS includes visual and optical systems

5. The system for identifying degraded positional information according to claim 1, wherein the one or more APS includes geophysical positioning

6. The system for identifying degraded positional information according to claim 1, wherein the error modeling module includes a calibration module configured, responsive to being in a calibration mode, to compare APS location data reports with ground truth data modeling corrections to the positional determination output of each APS.

7. The system for identifying degraded positional information according to claim 1, wherein the error modeling module computes an error correction estimate for each APS location data report for the position.

8. The system for identifying degraded positional information according to claim 7, wherein the APS error covariance correction is an aggregation of the error correction estimate for each APS location data report for the position.

9. The system for identifying degraded positional information according to claim 1,
wherein the metadata for the one or more GNSS location data reports includes GNSS measurement and collection data

10. The system for identifying degraded positional information according to claim 1, wherein the metadata for the one or more GNSS location data reports includes receiver configuration data

11. The system for identifying degraded positional information according to claim 1 wherein the metadata for the one or more GNSS location data reports includes spatial contextual data

12. The system for identifying degraded positional information according to claim 1 wherein the metadata for the one or more GNSS location data reports includes temporal and session data

13. The system for identifying degraded positional information according to claim 1 wherein the metadata for the one or more GNSS location data reports includes processing and validation data.

14. A method for identifying degraded positional information, the system comprising
producing by one or more Global Navigation Satellite System (GNSS) data sources one or more GNSS location data reports of a position and metadata regarding the one or more GNSS location data reports
producing one or more Alternative Positional Sources (APS) one or more APS location data reports for the position;
determining, by an error modeling module communicatively coupled to the one or more APS, an APS error covariance correction for the APS location data reports;
receiving, by a primary classifier communicatively coupled to the one or more GNSS data sources and the one or more APS data sources, the one or more GNSS location data reports, the one or more APS location data reports and the APS error covariance correction;
conducting, by the primary classifier, a generalized likelihood ratio test between the GNSS location data reports, the APS location data reports, and the APS error covariance correction thereby determining a primary GNSS data location report degradation assessment;
receiving, by a secondary classifier communicatively coupled to the one or more GNSS data sources, metadata for the one or more GNSS location data reports;
creating, by the secondary classifier, a secondary GNSS data location report degradation assessment; and
validating the primary classifier degradation assessment based on the secondary GNSS data location report degradation assessment and producing an GNSS positional degradation report.

15. The method for identifying degraded positional information according to claim 14, further comprising calibrating the error modeling module wherein responsive to being in a calibration mode, calibrating includes comparing APS location data reports with ground truth data modeling corrections to the positional determination output of each APS.

16. The method for identifying degraded positional information according to claim 14, further comprising, computing, by the error modeling module, an error correction estimate for each APS location data report for the position.

17. The method for identifying degraded positional information according to claim 14, aggregating error correction estimates for each APS location data report forming the APS error covariance correction.

18. The method for identifying degraded positional information according to claim 14, wherein the metadata for the one or more GNSS location data reports includes processing and validation data, temporal and session data, and/or spatial contextual data.

19. The method for identifying degraded positional information according to claim 14, wherein the one or more APS is selected from the group consisting of inertial navigation systems, terrestrial radio navigation systems, include visual and optical systems and geophysical positioning.
